(19) United States
(12) Patent Application Publication
(10) Pub. No.: US 2021/0052125 A1
(43) Pub. Date: Feb. 25, 2021

(54) ELECTRIC BLOWER, VACUUM CLEANER, AND HAND DRYER

(71) Applicant: Mitsubishi Electric Corporation, Tokyo (JP)

(72) Inventors: Haruka MATSUO, Tokyo (JP); Yuji TAKAYAMA, Tokyo (JP); Kazunori HATAKEYAMA, Tokyo (JP)

(21) Appl. No.: 16/964,684

(22) PCT Filed: Mar. 23, 2018
(86) PCT No.: PCT/JP2018/011812

§ 371 Date: Jul. 24, 2020

(51) Int. Cl. A47L 9/28; A47L 5/24; A47L 9/00; A47L 9/22; F04D 25/06; F04D 29/70; A45D 20/10

(52) U.S. Cl. CPC A47L 9/2889; A47L 5/24; A47L 9/0063; A45D 20/10; A47L 9/2884; F04D 25/06; F04D 29/701; A47L 9/22

(57) ABSTRACT

An electric blower includes a fan, and a board disposed in an airflow path of the fan and including a switching element. The board includes a lead wire projecting into the airflow path.

### CROSS REFERENCE TO RELATED APPLICATION

This application is a U.S. national stage application of International Patent Application No. PCT/JP2018/011812 filed on Mar. 23, 2018, the disclosure of which is incorporated herein by reference.

### TECHNICAL FIELD

The present invention relates to an electric blower, a vacuum cleaner, and a hand dryer.

### BACKGROUND

In electric blowers, there is known a configuration in which a first board including a power circuit and a second board including a signal circuit are disposed between a fan and a motor (see, e.g., Patent Literature 1).

There is also known a configuration in which a board is shielded from an airflow by a flange to prevent liquid carried by the airflow from adhering to the board (see, e.g., Patent Literature 2).

### PATENT LITERATURE

Patent Literature 1: Japanese Patent Application Publication No. 2002-21794 (see paragraphs 0031-0035)

Patent Literature 2: Japanese Patent Application Publication No. 2013-46569 (see paragraph 0021)

In the configuration disclosed in Patent Literature 1, it is possible to cool each board by using air blown by the fan. However, each board is coated with molded resin to prevent adhesion of foreign matter thereto, and the heat dissipation may be made insufficient due to the coating.

Also, in the configuration disclosed in Patent Literature 2, since the airflow is blocked by the flange, a heat sink for cooling the board is provided between the board and a motor. Thus, the manufacturing cost may increase, and heat generated by the motor may transfer through the heat sink to the board.

### SUMMARY

The present invention has been made to solve the above problems, and is intended to efficiently cool a board.

An electric blower of the present invention includes a fan; and a board disposed in an airflow path of the fan and including a switching element. The board includes a lead wire projecting into the airflow path.

With the present invention, since the board includes the lead wire in the airflow path, it is possible to dissipate heat from the lead wire with air blown by the fan. Thus, it is possible to efficiently cool the board.

### BRIEF DESCRIPTION OF DRAWINGS

FIG. 1A is a longitudinal sectional view illustrating an electric blower of a first embodiment, and FIG. 1B is a longitudinal sectional view illustrating a motor thereof.

FIG. 2 is a perspective view illustrating a rotor of the first embodiment.

FIG. 3A is a view illustrating blades of a stator of the first embodiment, FIG. 3B is a side view illustrating the stator, and FIG. 3C is a view illustrating air guide plates.

FIG. 4 is a transverse sectional view illustrating a motor (excluding a motor frame) of the first embodiment.

FIG. 5A is an enlarged view illustrating part of the motor of the first embodiment, and FIG. 5B is an enlarged view illustrating an insulator.

FIG. 6 is a transverse sectional view illustrating the motor of the first embodiment.

FIG. 7 is a block diagram illustrating a driving device of the electric blower of the first embodiment.

FIG. 8 is a diagram illustrating an electrical connection of switching elements and the motor of the first embodiment.

FIGS. 9A-9D are schematic views illustrating an example of an arrangement of electronic parts on a front surface (FIG. 9A) and a back surface (FIG. 9B) of a power board and a front surface (FIG. 9C) and a back surface (FIG. 9D) of a control board, in the first embodiment.

FIG. 10 is a view illustrating a vacuum cleaner using the electric blower of the first embodiment.

FIG. 11 is a view illustrating a state in which the vacuum cleaner illustrated in FIG. 10 is held by a stand.

FIG. 12 is a schematic view illustrating airflow in the electric blower of the first embodiment.

FIGS. 13A and 13B are respectively a side view and a front view illustrating an air guiding effect by the stator of the electric blower of the first embodiment.

FIG. 14 is a schematic view for explaining cooling effects on a first board and a second board of the electric blower of the first embodiment.

FIGS. 15A and 15B are schematic views for explaining an arrangement of electrolytic capacitors on the first board of the electric blower of the first embodiment.

FIG. 16 is a schematic view for explaining orientations of surfaces of the first board and second board when the electric blower of the first embodiment is not being used.

FIG. 17 is a schematic view for explaining orientations of the surfaces of the first board and second board when the electric blower of the first embodiment is being used.

FIG. 18 is a schematic view for explaining an orientation of an electronic part of the second board when the electric blower of the first embodiment is being used.

FIG. 19 is a plan view illustrating a connector of the first embodiment.

FIG. 20 is a side view illustrating a connector of a comparative example.

FIG. 21 is a view illustrating a hand dryer using the electric blower of the first embodiment.

### DETAILED DESCRIPTION

Embodiments of the present invention will be described in detail below with reference to the drawings. The present invention is not limited by the embodiments.

### First Embodiment

### <Configuration of Electric Blower 200>

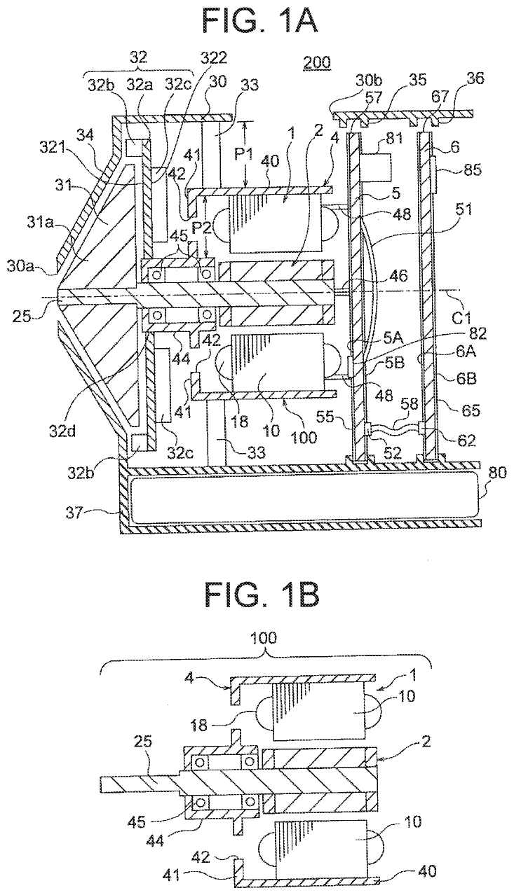

FIG. 1A is a longitudinal sectional view illustrating an electric blower 200 of a first embodiment of the present invention. The electric blower 200 includes a motor 100 including a rotating shaft 25, a rotor (fan) 31 attached to one end of the rotating shaft 25 of the motor 100, a stator 32 disposed adjacent to the rotor 31, a housing 30 that houses them, and a power board 5 (first board) and a control board 6 (second board) for controlling drive of the motor 100.

Hereinafter, a direction of an axis C1 that is a central axis of the rotating shaft 25 will be referred to as an “axial direction.” A circumferential direction about the axis C1 will be referred to as a “circumferential direction.” A radial direction about the axis C1 will be referred to as a “radial direction.” A sectional view of a cross-section parallel to the axial direction will be referred to as a “longitudinal sectional view,” and a sectional view of a cross-section perpendicular to the axial direction will be referred to as a “transverse sectional view.”

FIG. 1B is a longitudinal sectional view illustrating the motor 100 of the electric blower 200. The motor 100 is a permanent magnet synchronous motor, and is a single-phase motor driven by an inverter. The motor 100 includes a rotor 2 including the rotating shaft 25, a stator 1 disposed to surround the rotor 2, and a motor frame (also referred to simply as a frame) 4 inside which the stator 1 is fixed. A specific configuration of the stator 1 and rotor 2 will be described later.

The motor frame 4 includes a stator housing portion (or peripheral wall portion) 40, and a bearing housing portion 44 formed on the rotor 31 side of the stator housing portion 40. The stator housing portion 40 and bearing housing portion 44 both have cylindrical shapes about the axis C1. The stator 1 of the motor 100 is fitted to an inner side of the stator housing portion 40.

An outer diameter of the bearing housing portion 44 is smaller than an outer diameter of the stator housing portion 40. A wall portion 41 is formed between the stator housing portion 40 and the bearing housing portion 44. The wall portion 41 here extends in a direction perpendicular to the axis C1. A hole 42 that allows airflow to pass therethrough in the axial direction is formed in the wall portion 41.

Two bearings 45 (or bearing portions) are mounted inside the bearing housing portion 44. Outer races of the bearings 45 are fitted to an inner side of the bearing housing portion 44, and the rotating shaft 25 is press fitted in inner races of the bearings 45. The two bearings 45 are spaced from each other in the axial direction. A sleeve or the like may be disposed between the two bearings 45. The rotating shaft 25 projects through a hole formed in the bearing housing portion 44.

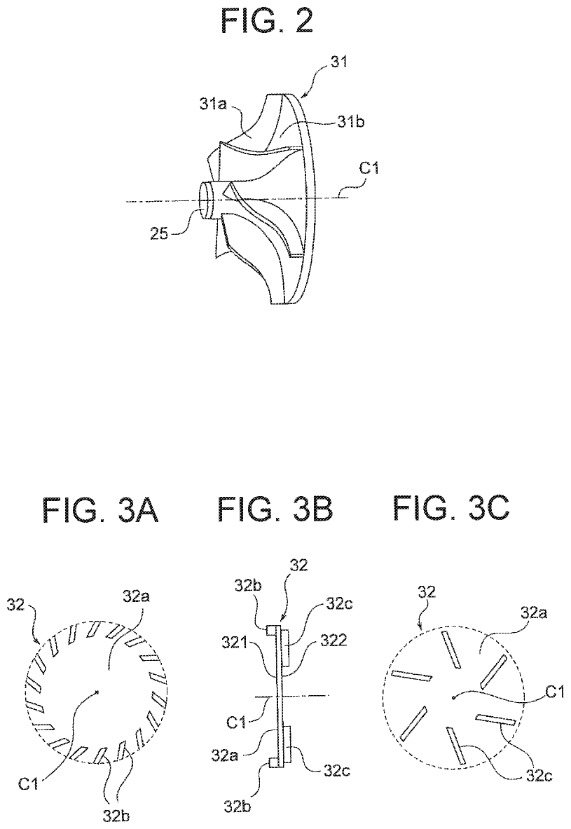

FIG. 2 is a perspective view illustrating an example in which the rotor 31 is a mixed flow fan. The rotor 31 illustrated in FIG. 2 includes multiple blades 31a on a surface of a hub 31b that is conical in shape about the axis C1. The rotor 31 generates airflow that is slanted relative to the axial direction and directed outward in the radial direction. The rotor 31 is not limited to a mixed flow fan, and may be, for example, a turbo fan.

Returning to FIG. 1A, the stator 32 includes a main plate 32a that is disk-shaped, multiple blades 32b formed on a first surface 321 of the main plate 32a on the rotor 31 side, and multiple air guide plates 32c (or air guides) formed on a second surface 322 on a side opposite the rotor 31. The stator 32 has, at its central portion in the radial direction, a hole 32d, and the bearing housing portion 44 is fitted in the hole 32d. The stator 32 is fixed by, for example, adhesion or screw fastening.

FIG. 3A is a view illustrating shapes and an arrangement of the blades 32b of the stator 32. FIG. 3B is a side view of the stator 32. FIG. 3C is a view illustrating shapes and an arrangement of the air guide plates 32c of the stator 32. FIGS. 3A and 3C each illustrate the shapes and arrangement as viewed from the rotor 31 side.

As illustrated in FIGS. 3A and 3B, the blades 32b are arranged at equal intervals in the circumferential direction, and each extend in a direction slanted relative to the radial direction. The blades 32b are formed in an outer peripheral region of the first surface 321, and located outside the rotor 31 (FIG. 2) in the radial direction. The blades 32b have the effect of rectifying airflow generated by rotation of the rotor 31.

As illustrated in FIGS. 3B and 3C, the air guide plates 32c are arranged at equal intervals in the circumferential direction, and each extend in a direction slanted relative to the radial direction. The slant direction of the air guide plates 32c is opposite the slant direction of the blades 32b. The air guide plates 32c extend inward beyond the blades 32b in the radial direction. The air guide plates 32c have the effect of directing airflow rectified by the blades 32b inward in the radial direction and guiding it toward the motor 100.

Returning to FIG. 1A, the electric blower 200 has a cantilever structure in which the rotating shaft 25 is supported by the two bearings 45 disposed between the rotor 31 and the stator 1 in the axial direction. The number of the bearings 45 is not limited to two, and may be three or more.

The housing 30 includes a fan cover 34 formed along the rotor 31, and an inlet 30a that faces a central portion of the rotor 31 in the radial direction. The housing 30 also includes at least one frame support 33 that supports the motor frame 4. Here, multiple frame supports 33 are disposed radially about the axis C1. An outlet 30b is formed in an outer peripheral wall of the housing 30, at a position facing an outer side in the radial direction of the stator 1.

The electric blower 200 has a path or airflow path of airflow entering the housing 30 through the inlet 30a. The airflow path of the electric blower 200 includes a first airflow path P1 outside the motor frame 4 and a second airflow path P2 inside the motor frame 4. Airflow flowing through the first airflow path P1 passes through the outside of the motor frame 4 in the axial direction, and airflow flowing through the second airflow path P2 passes through the motor 100 in the axial direction.

The power board 5 and control board 6, which control drive of the motor 100, are disposed on a side of the motor 100 opposite the rotor 31. The power board 5 includes a front surface 5A (first surface) facing the motor 100 and a back surface 5B (second surface) opposite thereto. The control board 6 includes a front surface 6A (first surface) facing the power board 5 and a back surface 6B (second surface) opposite thereto.

The power board 5 and control board 6 include electronic parts necessary for control of drive of the motor 100. For example, the power board 5 includes switching elements 82a to 82d of an inverter 82, at least one electrolytic capacitor 81, and at least one shunt resistor 84, and the control board 6 includes a microcomputer 85. Separating the power board 5 and control board 6 as described above allows reduction in size (diameter) of the electric blower 200.

The front surface 5A and back surface 5B of the power board 5 are coated with a coating 55 made of moisture proof material. Likewise, the front surface 6A and back surface 6B of the control board 6 are coated with a coating 65 made of moisture proof material.

The power board 5 is mounted in a board holding portion 35 provided in the housing 30. The board holding portion 35 is formed along an inner periphery of the housing 30, and holds an outer peripheral portion of the power board 5. Likewise, the control board 6 is mounted in a board holding portion 36 provided in the housing 30. The board holding portion 36 is formed along an inner periphery of the housing 30, and holds an outer peripheral portion of the control board 6. Cutouts 57 and 67 for allowing airflow to pass therethrough are provided in portions of the outer peripheral portions of the power board 5 and control board 6, respectively.

There are disposed, between the stator 1 and the power board 5, connecting terminals 48 for positioning and electrically connecting the stator 1 and power board 5, and a sensor guide 46 that guides lead wires of a sensor 16 (described later) of the motor 100.

A battery housing portion 37, which is a hollow portion, is formed on one side (a lower side in FIG. 1A) of the housing 30 in the radial direction. A battery 80 that is a power source of the motor 100 is housed in the battery housing portion 37.

### <Configuration of Motor 100>

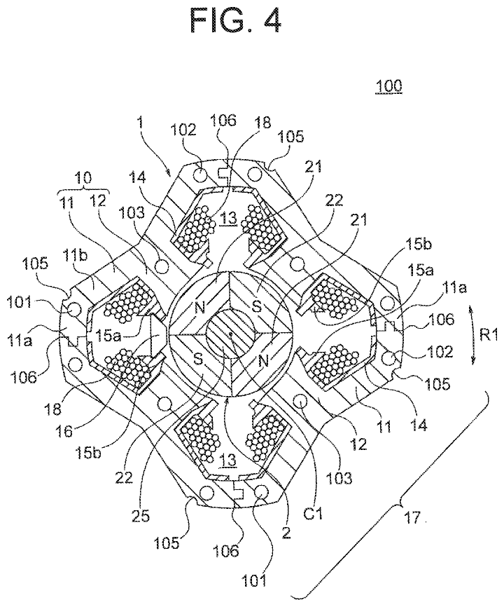

FIG. 4 is a sectional view illustrating the motor 100 of the first embodiment. In FIG. 4, the motor frame 4 is omitted. The motor 100 includes the rotor 2 and stator 1 disposed to surround the rotor 2, as described above. The rotor 2 rotates about the axis C1 counterclockwise in the drawing.

The rotor 2 includes the rotating shaft 25, and permanent magnets 21 and 22 fixed around the rotating shaft 25. The permanent magnets 21 and 22 are arranged at equal intervals in the circumferential direction, and each form a magnetic pole. Outer peripheries of the permanent magnets 21 are, for example, north poles, and outer peripheries of the permanent magnets 22 are, for example, south poles, but this may be reversed.

Here, the two permanent magnets 21 and two permanent magnets 22 are arranged alternately in the circumferential direction. Thus, the rotor 2 has four magnetic poles. However, the number of magnetic poles of the rotor 2 is not limited to four, and only required to be two or more.

The stator 1 is disposed outside the rotor 2 in the radial direction with an air gap therebetween. The stator 1 includes a stator core 10, insulators 14, and a coil 18. The stator core 10 is obtained by stacking multiple stacked elements in the axial direction and fixing them together at swaged portions 101, 102, and 103. The stacked elements are here electromagnetic steel sheets, and have thicknesses of, for example, 0.25 mm.

The stator core 10 includes a yoke 11 surrounding the rotor 2 and multiple teeth 12 each extending in a direction from the yoke 11 toward the rotor 2 (or inward in the radial direction). The teeth 12 are arranged at equal intervals in the circumferential direction. The number of the teeth 12 is equal to the number of magnetic poles of the rotor 2, and is four here.

In the stator core 10, a slot 13 is formed between each two of the teeth 12 adjacent to each other in the circumferential direction. The insulators 14, which are made of insulating resin, are disposed in the slots 13. The coil 18 is wound around the teeth 12 with the insulators 14 therebetween.

The yoke 11 of the stator core 10 includes multiple arc-shaped back yokes 11a, and linear connecting yokes (joint portions) 11b located inside the back yokes 11a in the radial direction. The back yokes 11a are portions of the stator 1 located outermost in the radial direction, and are arranged at equal intervals in the circumferential direction.

The number of the back yokes 11a is equal to the number of the teeth 12, and is four here. Each of the teeth 12 is located between two of the back yokes 11a adjacent to each other in the circumferential direction. Outer peripheries of the back yokes 11a are fitted to an inner periphery of the stator housing portion 40 of the motor frame 4 (FIG. 1A).

Each connecting yoke 11b extends to connect a back yoke 11a and a tooth 12. Each connecting yoke 11b linearly extends so that it extends inward in the radial direction as it extends away from the back yoke 11a. Each tooth 12 extends toward the rotor 2 from a portion where two of the connecting yokes 11b adjacent to each other in the circumferential direction are connected in V-shape (or a portion of the yoke 11 located innermost in the radial direction).

Split surfaces (or split fitting portions) 106 are formed at a center of each back yoke 11a in the circumferential direction. The stator core 10 is split into multiple blocks, or split cores 17, for the respective teeth 12 at the split surfaces 106 formed in the back yokes 11a. Here, the stator core 10 is split into four split cores 17.

The split surfaces 106 each have a projection or a recess. For each two of the split cores 17 adjacent to each other in the circumferential direction, a projection of a split surface 106 of one of the two split cores 17 and a recess of a split surface 106 of the other of the two split cores 17 are fitted together.

The multiple stacked elements constituting the stator core 10 are fixed together by the swaged portions 101, 102, and 103. The swaged portions 101 and 102 are formed in the yoke 11, and the swaged portions 103 are formed in the teeth 12.

Fixing recesses 105, which are grooves elongated in the axial direction, are formed in outer peripheries of the back yokes 11a of the yoke 11. In a state where the stator core 10 is engaged with the stator housing portion 40 (FIG. 1A) of the motor frame 4, portions of the stator housing portion 40 are pressed from the outer periphery side to be deformed and fitted into the fixing recesses 105. This prevents rotation of the stator 1 in the motor frame 4. The fixing recesses 105 can be omitted.

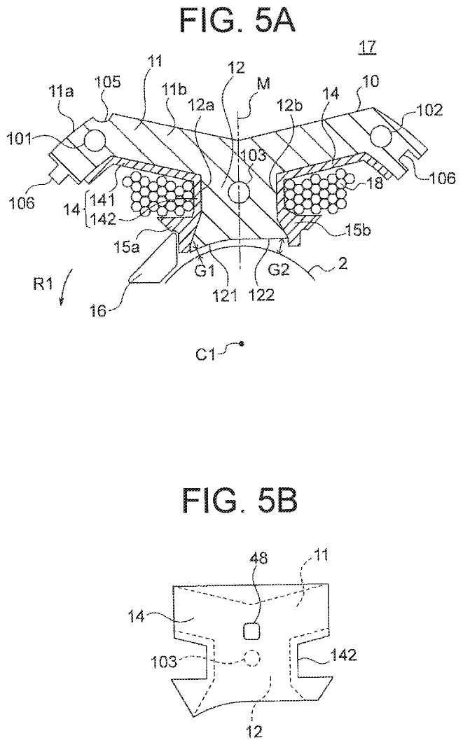

FIG. 5A is an enlarged view illustrating part of the stator 1. Each tooth 12 has a first side portion 12a that is an edge on the downstream side (left side in the drawing) in a rotational direction of the rotor 2, and a second side portion 12b that is an edge on the upstream side (right side in the drawing). The first side portion 12a and second side portion 12b each extend parallel to a straight line M in the radial direction passing through a center of the tooth 12 in the circumferential direction (or a center position between the side portions 12a and 12b in the circumferential direction).

An inner end (referred to below as a tip) of each tooth 12 in the radial direction has a shape asymmetric with respect to the straight line M. In particular, a leading edge of each tooth 12 facing the rotor 2 has a first leading edge 121 located on the downstream side in the rotational direction of the rotor 2, and a second leading edge 122 located on the upstream side.

The first leading edge 121 curves in an arc along an outer periphery of the rotor 2, and the second leading edge 122 linearly extends. The first leading edge 121 and second leading edge 122 are connected at a center of the tooth 12 in the circumferential direction. Thus, the distance between the tooth 12 and the rotor 2 is greater on the upstream side (distance G2) than on the downstream side (distance G1) in the rotational direction of the rotor 2.

Each insulator 14 includes an inner wall portion 141 along an inner surface of the yoke 11, and a side wall portion 142 surrounding a periphery (specifically, the side portions 12a and 12b and both end surfaces in the axial direction) of a tooth 12. Each insulator 14 is formed by forming resin integrally with the stator core 10 or mounting, to the stator core 10, a resin formed body formed as a separate part.

Sensor fixing portions 15a and 15b are disposed on both sides of the tip of each tooth 12 in the circumferential direction. The sensor fixing portion 15a is disposed on the first side portion 12a side, and the sensor fixing portion 15b is disposed on the second side portion 12b side. The sensor fixing portions 15a and 15b each project in the circumferential direction from the tip of the tooth 12. Here, the sensor fixing portions 15a and 15b are formed integrally with the insulator 14. Specifically, the sensor fixing portions 15a and 15b are formed in such a manner as to be connected to the side wall portion 142 of the insulator 14.

Returning to FIG. 4, between each two of the teeth 12 adjacent to each other in the circumferential direction, sensor fixing portions 15a and 15b face each other. Here, the stator 1 includes four sets of sensor fixing portions 15a and 15b. The sensor (specifically, a magnetic pole position sensor) 16 for detecting the positions of the magnetic poles of the rotor 2 is held between the sensor fixing portions 15a and 15b of one of the four sets of sensor fixing portions 15a and 15b of the stator 1.

The sensor 16 is obtained by integrating a Hall effect device with a resin package, and has an end surface in the axial direction from which the lead wires are drawn. The sensor 16 is disposed to face the outer periphery of the rotor 2 so as to detect the positions of the magnetic poles from the magnetic field of the rotor 2. The sensor 16 is attached to a tip of the sensor guide 46 extending in the axial direction from the power board 5 toward the stator 1.

FIG. 5B is a schematic view illustrating a shape of an insulator 14 as viewed from the power board 5 side (FIG. 1A). A connecting terminal 48, which is made of metal (conductor) and projects toward the power board 5 (FIG. 1A), is disposed in a portion of the insulator 14 covering an end surface of the stator 1 in the axial direction. The connecting terminal 48 is fixed to the power board 5 with solder. The connecting terminal 48 positions the power board 5 with respect to the stator 1 and electrically connects the coil 18 of the motor 100 and a pattern of the power board 5.

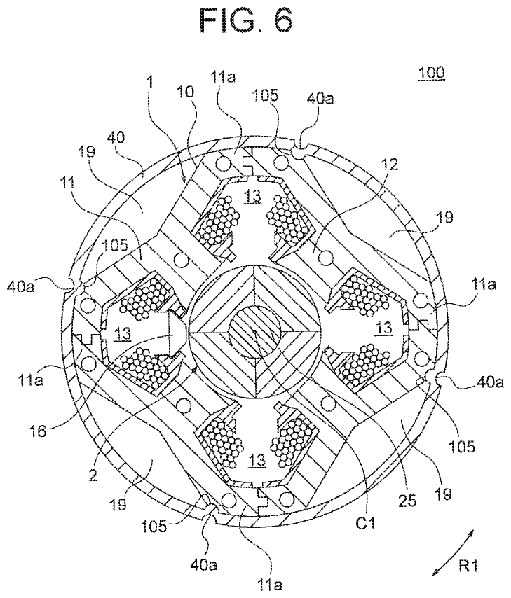

FIG. 6 is a transverse sectional view illustrating the motor 100. When the stator 1 is mounted in the motor frame 4 (FIG. 1A), the outer peripheries of the back yokes 11a of the stator 1 are fitted to the inner periphery of the stator housing portion 40. The stator 1 has the fixing recesses 105, and portions of the stator housing portion 40 corresponding to the fixing recesses 105 are applied with external force to be dented (as indicated by reference character 40a) and engaged with the fixing recesses 105. This can prevent displacement of the stator 1 in the circumferential direction.

In the example illustrated in FIGS. 4 to 6, the tip of each tooth 12 has a shape asymmetric with respect to the straight line M in the radial direction passing through a center in a width direction of the tooth 12, but such a shape is not mandatory, and it may have, for example, a shape symmetric with respect to the straight line M. Also, the yoke 11 of the stator core 10 is not limited to one having the back yokes 11a and connecting yokes 11b, and may be, for example, a single annular yoke.

### <Driving Device of Electric Blower 200>

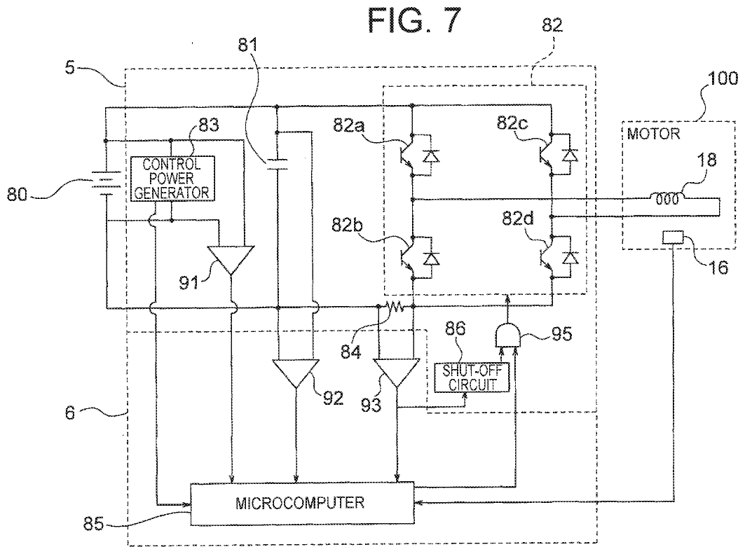

FIG. 7 is a block diagram illustrating a driving device of the electric blower 200 of the first embodiment. The driving device of the electric blower 200 includes the battery 80, the electrolytic capacitor 81, the inverter 82, a control power generator 83, the shunt resistor 84, the microcomputer 85 as a control device, a shut-off circuit 86, and voltage sensors 91, 92, and 93.

The battery 80 supplies a direct-current voltage (or battery voltage) of, for example, 20 V. The electrolytic capacitor 81 charges the voltage supplied from the battery 80 and supplies it to the inverter 82. The voltage sensor 91 detects the voltage of the battery 80, and the voltage sensor 92 detects the voltage of the electrolytic capacitor 81. Instead of the battery 80, an alternating-current power source and rectifying diode(s) may be used.

Using the voltage of the electrolytic capacitor 81, the inverter 82 performs switching operation and supplies voltage to the motor 100. Specifically, the inverter 82 includes the four switching elements 82a, 82b, 82c, and 82d arranged in an H-bridge. The switching elements 82a, 82b, 82c, and 82d perform on-off operation in accordance with driving signals from the microcomputer 85 to generate single-phase current and supply it to the motor 100.

The switching elements can be formed by, for example, insulated gage bipolar transistors (IGBTs) or metal-oxide-semiconductor field-effect transistors (MOSFETs). They can also be formed by MOSFETs with super junction structures, or SiC or GaN, which are wide band gap semiconductors.

The shunt resistor 84 is connected between the inverter 82 and the electrolytic capacitor 81. A voltage equal to the product of the current flowing through the shunt resistor 84 and the resistance occurs between both ends of the shunt resistor 84, and the voltage is detected by the voltage sensor 93. When excessive current flows through the shunt resistor 84, the voltage sensor 93 outputs a shut-off signal, and the shut-off signal is input to the microcomputer 85 and shut-off circuit 86.

The microcomputer 85 generates PWM signals, which are control signals, for on-off control of the switching elements 82a to 82d of the inverter 82, and outputs them to the inverter 82. The microcomputer 85 is obtained by mounting, on one chip, an arithmetic circuit that performs arithmetic processing necessary for control of the motor 100.

An output of the microcomputer 85 and an output of the shut-off circuit 86 are input to the inverter 82 via an AND circuit 95. When shut-off signals are output from the shut-off circuit 86 and microcomputer 85, the switching operation of the inverter 82 stops.

When the voltage of the electrolytic capacitor 81 decreases due to voltage supply to the motor 100, the voltage of the battery 80 is supplied to the electrolytic capacitor 81 and the voltage of the electrolytic capacitor 81 returns. Thus, the voltage detected by the voltage sensor 91 is substantially equal to the voltage detected by the voltage sensor 92. An output of the voltage sensor 91 and an output of the voltage sensor 92 (which are both analog signals) are input to the microcomputer 85.

Detecting the voltages of the battery 80 and electrolytic capacitor 81 with the voltage sensors 91 and 92 enables the microcomputer 85 to determine the voltage supplied to the inverter 82. The microcomputer 85 determines how the switching operation should be performed for the voltage supplied to the inverter 82. For example, when the voltage supplied to the inverter 82 is 20 V and a voltage of 10 V is supplied to the motor 100, the inverter 82 is turned on at a duty cycle of 50%.

The control power generator 83 is connected in parallel to the battery 80. The control power generator 83 generates a control voltage (e.g., 5 V) used by the microcomputer 85 or the like, from the voltage (e.g., 20 V) of the battery 80.

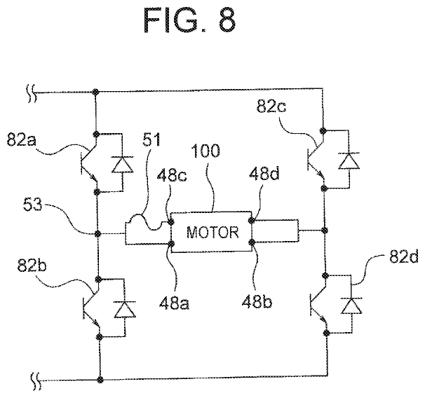

FIG. 8 is a diagram illustrating an electrical connection of the inverter 82 and motor 100. In the inverter 82, a series connection of the switching elements 82a and 82b and a series connection of the switching elements 82c and 82d are connected in parallel.

The coil 18 of the motor 100 is connected to the switching elements 82a and 82b through connecting terminals 48a and 48c and connected to the switching elements 82c and 82d through connecting terminals 48b and 48d. A lead wire 51 is disposed between the connecting terminal 48c and the switching elements 82a and 82b. The connecting terminals 48a to 48d and lead wire 51 will be described later.

For example, when the switching elements 82a and 82d are simultaneously turned on, current flows through the switching element 82a, motor 100, switching element 82d, and shunt resistor 84 in this order. Also, when the switching elements 82b and 82c are simultaneously turned on, current flows through the switching element 82c, motor 100, switching element 82b, and shunt resistor 84 in this order.

Of the electronic parts illustrated in FIG. 7, the inverter 82 (or the switching elements 82a to 82d) generates a large amount of heat, and thus is provided in the power board 5, which is exposed directly to the airflow flowing through the first airflow path P1 and second airflow path P2. Also, while the microcomputer 85 generates a small amount of heat, it has a narrow wiring pitch, and it is required to prevent foreign matter from adhering to the microcomputer 85. Thus, the microcomputer 85 is provided in the control board 6 downstream of the power board 5.

Since the electrolytic capacitor 81 and shunt resistor 84 are applied with relatively high voltages and carry relatively high currents, they are desirably provided in the power board 5, which is exposed directly to the airflow.

Each of the control power generator 83, shut-off circuit 86, voltage sensor 91, voltage sensor 92, and AND circuit 95 may be provided in either the power board 5 or control board 6.

However, providing the voltage sensor 93, shut-off circuit 86, and AND circuit 95 for overcurrent protection in the power board 5 as with the shunt resistor 84 and inverter 82 provides an advantage of allowing the wiring length to be reduced. Also, since the control power generator 83 supplies the control voltage to the microcomputer 85, it may be provided in the control board 6 as with the microcomputer 85.

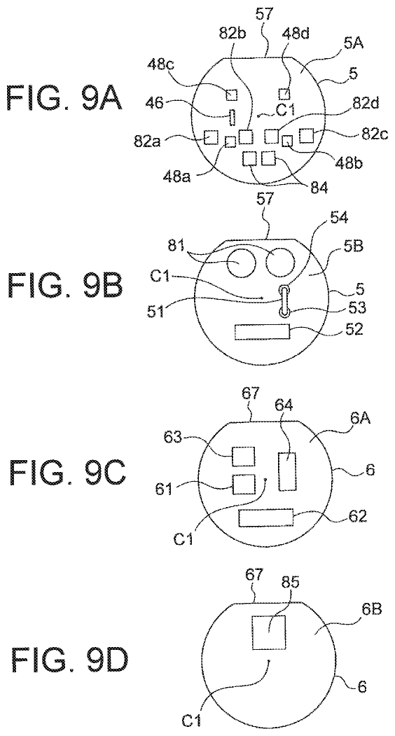

FIGS. 9A, 9B, 9C, and 9D are schematic views illustrating an example of an arrangement of the electronic parts in the power board 5 and control board 6. They illustrate major ones of the electronic parts illustrated in FIG. 7. FIGS. 9A to 9D illustrate the power board 5 and control board 6 with the battery 80 side (FIG. 1A) down.

FIG. 9A is a schematic view illustrating an example of an arrangement of electronic parts on the front surface 5A (or a surface on the motor 100 side) of the power board 5. The connecting terminals 48 to the motor 100, the sensor guide 46, the switching elements 82a, 82b, 82c, and 82d of the inverter 82, and the at least one shunt resistor 84 are arranged on the front surface 5A of the power board 5.

The connecting terminals 48 are fixed to the power board 5 with solder, as described above. Here, the number of the connecting terminals 48 is four, and they are denoted by reference characters 48a, 48b, 48c, and 48d. The connecting terminals 48a to 48d are arranged at positions corresponding to the four corners of a square, but such an arrangement is not mandatory. The number of the connecting terminals 48a to 48d is not limited to four, and may be three or less or five or more.

The sensor guide 46 is disposed between the two connecting terminals 48a and 48c, which are adjacent to each other in the circumferential direction, and is disposed at equal distances from the connecting terminals 48a and 48c. Disposing the sensor guide 46 at equal distances from the connecting terminals 48a and 48c as described above prevents displacement of the sensor 16 (FIG. 4), which is disposed at the tip of the sensor guide 46, in the circumferential direction.

The switching elements 82a to 82d are arranged in a row, the connecting terminal 48a is located between the switching elements 82a and 82b, and the connecting terminal 48b is located between the switching elements 82c and 82d. However, such an arrangement is not mandatory. Here, the number of the at least one shunt resistor 84 is two, but may be one or three or more.

FIG. 9B is a schematic view illustrating an example of an arrangement of electronic parts on the back surface 5B (or a surface on a side opposite the motor 100) of the power board 5. The lead wire 51 is disposed on the back surface 5B of the power board 5. The lead wire 51 connects a terminal portion 54 connected to the connecting terminal 48c via a through-hole in the power board 5 and a connection 53 (FIG. 8) between the switching elements 82a and 82b.

The lead wire 51 is formed by litz wire. Litz wire is obtained by twisting multiple conductor element wires insulated from each other, and has an advantage that it can reduce skin effect when high-frequency current flows and reduce temperature rise.

The lead wire 51 is disposed on the back surface 5B of the power board 5 in such a manner as to project through the coating 55 to the outside, as illustrated in FIG. 1A. In other words, the lead wire 51 projects into the airflow path so as to be exposed to airflow flowing into the back surface 5B side of the power board 5. While the lead wire 51 carries a high current and generates heat, it is exposed to the airflow and thereby cooled efficiently.

The at least one electrolytic capacitor 81 is also disposed on the back surface 5B of the power board 5. Here, the number of the at least one electrolytic capacitor 81 is two, but may be one or three or more. The electrolytic capacitors 81 are desirably disposed nearer to an outer periphery on a side away from the battery 80 (FIG. 1A) of the back surface 5B of the power board 5.

A terminal portion 52 to which a connector 58 for electrically connecting the power board 5 and the control board 6 is connected is also disposed on the back surface 5B of the power board 5.

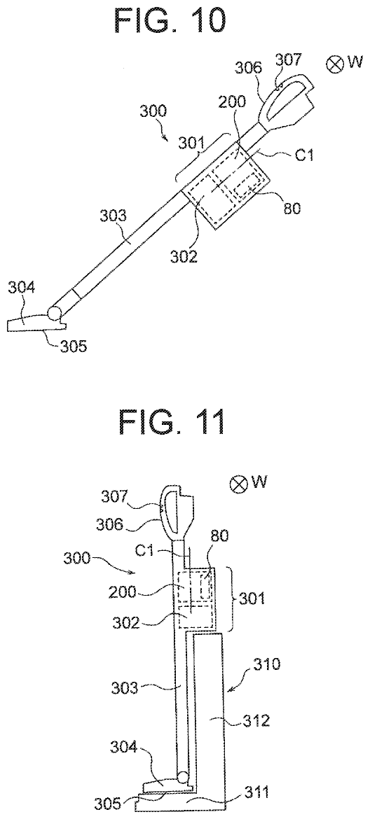

FIG. 9C is a schematic view illustrating an example of an arrangement of electronic parts on the front surface 6A (or a surface on the power board 5 side) of the control board 6. A MOSFET 64, an operational amplifier 63, and a logic IC 61 are disposed on the front surface 6A of the control board 6. Although omitted in FIG. 7, they are used for control of the motor 100. For example, the MOSFET 64 allows charging of the battery 80 in a state where a vacuum cleaner 300 (FIG. 10) including the electric blower 200 is held by a stand 310 (FIG. 11).

A terminal portion 62 to which the connector 58 is connected is also disposed on the front surface 6A of the control board 6. The control power generator 83 (FIG. 7) may also be disposed on the front surface 6A of the control board 6.

FIG. 9D is a schematic view illustrating an example of an arrangement of electronic parts on the back surface 6B (or a surface on a side opposite the power board 5) of the control board 6. The microcomputer 85 is disposed on the back surface 6B of the control board 6. Since the microcomputer 85 is the electronic part that most needs to be kept from adhesion of foreign matter (dust, liquid, or the like), it is disposed on the most downstream side in the airflow.

### <Vacuum Cleaner>

The vacuum cleaner 300 using the electric blower 200 of the first embodiment will now be described. FIG. 10 is a schematic view illustrating the vacuum cleaner 300 using the electric blower 200. The vacuum cleaner 300 includes a cleaner body 301, a pipe 303 connected to the cleaner body 301, and a suction portion 304 connected to a tip of the pipe 303.

A suction port 305 for sucking air containing dust is provided in the suction portion 304. A dust collection container 302 is disposed in the cleaner body 301. In the case of a stick vacuum cleaner, the suction portion 304 and cleaner body 301 may be directly connected to each other without providing the pipe 303.

The electric blower 200, which sucks air containing dust through the suction portion 304 into the dust collection container 302, is disposed in the cleaner body 301. The electric blower 200 has, for example, the configuration illustrated in FIG. 1A.

When the rotor 31 (FIG. 1A) of the electric blower 200 rotates, airflow is generated, dust is sucked together with air through the suction port 305 of the suction portion 304, and the sucked dust is stored in the dust collection container 302. A direction (indicated by arrow A in FIG. 10) in which the air is sucked from the suction portion 304 to the dust collection container 302 is parallel to the direction of the axis C1 (i.e., a direction of a rotation axis of the rotating shaft 25) of the electric blower 200 illustrated in FIG. 1A. A longitudinal direction of the vacuum cleaner 300 is also parallel to the suction direction A from the suction portion 304 to the dust collection container 302.

A grip 306 to be held by a user is provided on a side of the cleaner body 301 opposite the suction portion 304. The grip 306 is provided with an operation portion 307, such as an on-off switch. The grip 306 has a width W in a direction perpendicular to the suction direction A to allow a user to easily hold it.

FIG. 11 is a schematic view illustrating a state where the vacuum cleaner 300 is placed when it is not being used. When the vacuum cleaner 300 is not being used, it is held by the stand 310 in a standing position. The stand 310 includes a base 311 and a support post 312 extending vertically upward from the base 311. The suction portion 304 of the vacuum cleaner 300 is placed on the base 311, and the cleaner body 301 is placed on an upper portion of the support post 312. The vacuum cleaner 300 is held by the stand 310 in a standing position in such a manner that the suction direction A from the suction portion 304 to the dust collection container 302 coincides with a vertical direction. The stand 310 also has a function as a charge stand for charging the battery 80 of the vacuum cleaner 300, the description of which is omitted.

### <Operation>

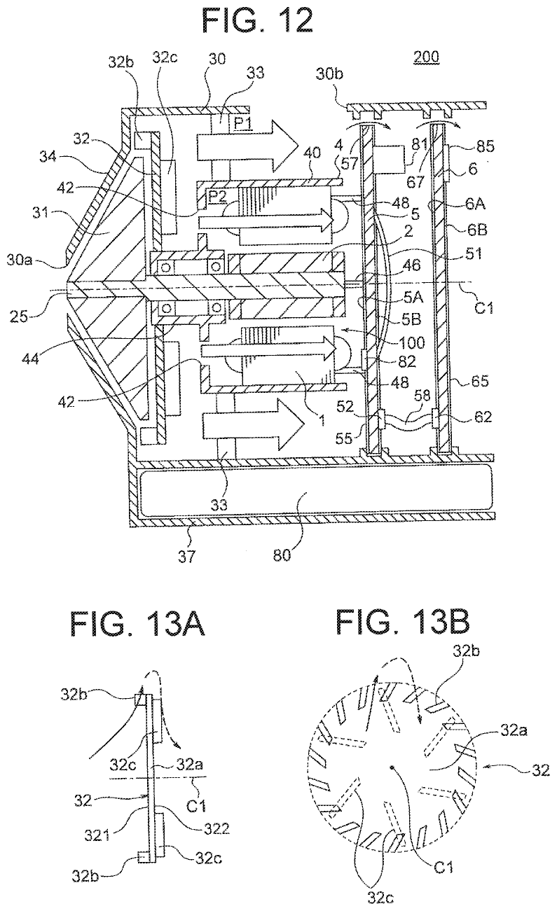

Next, operation of the electric blower 200 of the first embodiment will be described. FIG. 12 is a view illustrating airflow in the electric blower 200. When the motor 100 is rotated by energization of the coil 18, the rotating shaft 25 rotates, and the rotor 31 rotates. When the rotor 31 rotates, air flows into the housing 30 through the inlet 30a.

FIGS. 13A and 13B are respectively a side view and a front view from the rotor 31 side that illustrate operation of the stator 32. As illustrated in FIGS. 13A and 13B, the blades 32b of the stator 32 rectify airflow (indicated by the solid arrows) flowing along the rotor 31 and guide it outward in the radial direction. On the other hand, the air guide plates 32c of the stator 32 guide airflow passing through the blades 32b inward in the radial direction as indicated by the dashed arrows.

Thus, as illustrated in FIG. 12, a part of the airflow passing through the stator 32 flows through the first airflow path P1 outside the motor frame 4 in the axial direction. Also, another part of the airflow passing through the stator 32 is guided by the air guide plates 32c of the stator 32 inward in the radial direction, flows into the motor frame 4 through the hole 42, and flows through the second airflow path P2 in the axial direction.

The airflow flowing into the motor frame 4 flows in the axial direction through gaps 19 between the stator 1 and the stator housing portion 40, the insides of the respective slots 13 of the stator 1, and the air gap between the stator 1 and the rotor 2, which are illustrated in FIG. 6. Thus, heat generated by the coil 18 can be dissipated by the airflow flowing through the second airflow path P2.

Also, dust is sucked together with air through the suction portion 304 of the vacuum cleaner 300 (FIG. 10) due to the airflow generated by rotation of the rotor 31. The sucked dust moves toward the dust collection container 302 through the pipe 303 and is stored in the dust collection container 302.

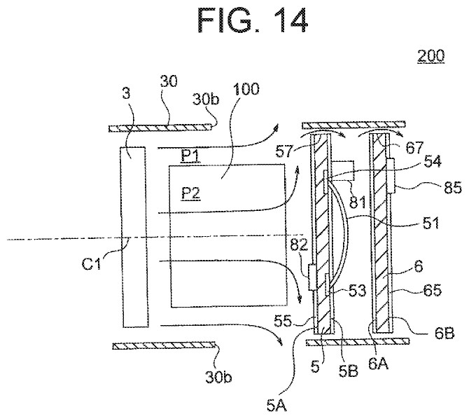

FIG. 14 is a schematic view for explaining cooling effects on the power board 5 and control board 6. In FIG. 14, the rotor 31 and stator 32 illustrated in FIG. 1A are illustrated as a blower portion 3. As illustrated in FIG. 14, airflow flowing through the first airflow path P1 and second airflow path P2 of the electric blower 200 strikes the front surface 5A of the power board 5 and cools the switching elements 82a to 82d, shunt resistors 84 (FIG. 9A), and the like disposed on the front surface 5A.

The switching elements 82a to 82d and shunt resistors 84 are electronic parts that generate large amounts of heat and tend to increase in temperature. Thus, they can be effectively cooled by exposing them directly to the airflow flowing through the first airflow path P1 and second airflow path P2.

Airflow striking the front surface 5A of the power board 5 is directed outward in the radial direction. While much of the airflow directed outward in the radial direction on the front surface 5A of the power board 5 is exhausted through the outlet 30b, part thereof enters the back surface 5B side through the cutout 57 of the power board 5.

The airflow entering the back surface 5B side of the power board 5 cools the lead wire 51 and electrolytic capacitors 81 disposed on the back surface 5B. The lead wire 51 carries current through the switching elements 82a to 82d, and thus generates a large amount of heat. Exposing the lead wire 51 to the airflow can efficiently dissipate the heat.

Further, since the lead wire 51 projects to the outside through the coating 55 of the power board 5, the lead wire 51 may come off if it is exposed to a strong airflow. Here, since the lead wire 51 is disposed on the back surface 5B of the power board 5 so that it is not exposed directly to the airflow flowing through the first airflow path P1 and second airflow path P2, the lead wire 51 can be prevented from coming off.

Further, if the lead wire 51 is disposed on the control board 6 including electronic parts carrying low currents, the lead wire 51 acts as an antenna and makes it more susceptible to external noise. Thus, the lead wire 51 is disposed on the power board 5 including electronic parts carrying high currents (that is, electronic parts less susceptible to noise).

The lifetimes of the electrolytic capacitors 81 tend to decrease at high temperature, and heights (here, dimensions in the axial direction) of the electrolytic capacitors 81 are relatively high. Thus, if the electrolytic capacitors 81 are disposed on the front surface 5A of the power board 5, they are too close to the motor 100, and may be affected by heat from the motor 100.

Thus, the electrolytic capacitors 81 are disposed on the back surface 5B of the power board 5. Thereby, it is possible to prevent the electrolytic capacitors 81 from being affected by heat from the motor 100, and cool the electrolytic capacitors 81 with the airflow passing through the cutout 57 of the power board 5.

Part of the airflow passing through the cutout 57 of the power board 5 also reaches the front surface 6A of the control board 6 and cools the MOSFET 64, operational amplifier 63, and logic IC 61 (FIG. 9C) disposed on the front surface 6A.

Also, part of the airflow passing through the cutout 57 of the power board 5 enters the back surface 6B side of the control board 6 through the cutout 67 of the control board 6. The airflow entering the back surface 6B side of the control board 6 cools the microcomputer 85 disposed on the back surface 6B.

The microcomputer 85, MOSFET 64, operational amplifier 63, and logic IC 61 are each an electronic part that is applied with a low voltage and carries a low current, and thus each generates a small amount of heat. Since these electronic parts (also referred to as narrow-pitch parts) each have a wiring pitch that is narrow, e.g., about 0.5 mm to 0.65 mm, it is undesirable that foreign matter (dust, liquid, or the like) enter spaces between wires.

In this embodiment, the microcomputer 85, MOSFET 64, operational amplifier 63, and logic IC 61 are disposed in the control board 6 behind the power board 5, not in the power board 5, which is exposed directly to the airflow flowing through the first airflow path P1 and second airflow path P2. This can prevent foreign matter from entering the spaces between the wires.

Rotation of the rotor 31 may suck liquid together with air through the inlet 30a. However, the power board 5 and control board 6 are coated with the coatings 55 and 65 of moisture proof material, and thus it is possible to prevent adhesion of liquid to spaces in patterns or portions between wires of the electronic parts, thereby preventing dielectric breakdown, or corrosion and wire breakage.

The switching elements 82a to 82d disposed on the power board 5 have wider wiring pitches than the microcomputer 85 or the like. Thus, even if the coating 55 is not provided on the power board 5, dielectric breakdown or corrosion and wire breakage due to adhesion of liquid is less likely to occur.

When the coating 55 of moisture proof material is provided on the power board 5, the efficiency of heat dissipation from the power board 5 is lower than when the coating 55 is not provided. However, by using the airflow flowing through the first airflow path P1 and second airflow path P2, it is possible to obtain sufficient efficiency of cooling of the power board 5.

Further, since the connecting terminals 48 connecting the power board 5 and motor 100 are also exposed to the airflow flowing through the first airflow path P1 and second airflow path P2, heat from the power board 5 can also be dissipated through the connecting terminals 48.

Further, since the sensor guide 46 is equidistant from the adjacent connecting terminals 48a and 48c in the power board 5, even when the motor 100 or power board 5 is subjected to stress, the sensor 16 (FIG. 4), which is disposed at the tip of the sensor guide 46, can be prevented from displacing in the circumferential direction.

Since the positional accuracy of the sensor 16 in the circumferential direction affects detection of the positions of the magnetic poles of the rotor 2 (or a rotational position of the rotor 2), preventing displacement of the sensor 16 in the circumferential direction improves the accuracy in rotation of the rotor 2. This allows stable operation of the motor 100, allowing improvement in performance of the electric blower 200.

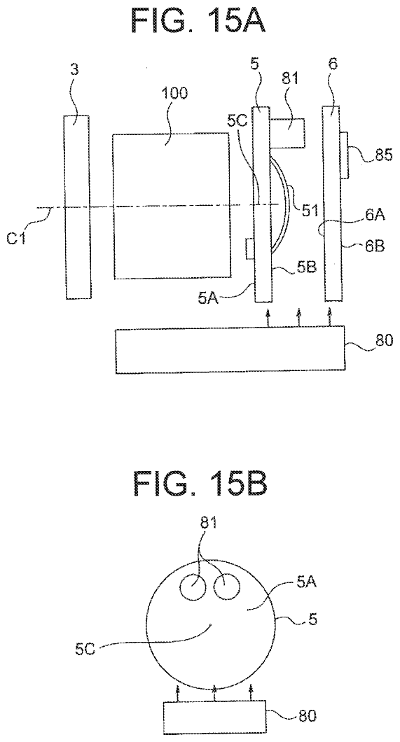

Next, an arrangement of the electrolytic capacitors 81 of the power board 5 will be described. FIG. 15A is a schematic view illustrating a positional relationship between the electrolytic capacitors 81 of the power board 5 and the battery 80, with the housing 30 omitted. The power board 5 is disposed so that normal directions of the front surface 5A and back surface 5B are parallel to the axial direction (i.e., the direction of the axis C1).

A portion of the power board 5 corresponding to the axis C1 (or a rotation center of the rotating shaft 25) will be referred to as the central portion 5C. The electrolytic capacitors 81 are disposed on a side of the central portion 5C of the power board 5 opposite the battery 80. Thus, the electrolytic capacitors 81 are disposed at a position farthest from the battery 80 on the power board 5.

FIG. 15B is a view of the power board 5 and battery 80 as viewed from the control board 6 side. While the electrolytic capacitors 81 are electronic parts whose lifetimes tend to decrease at high temperature as described above, disposing them at a position farthest from the battery 80 on the power board 5 can reduce the effect of heat from the battery 80 and prevent the reduction in the lifetimes.

Next, orientations of the power board 5 and control board 6 when the electric blower 200 is not being used and when the electric blower 200 is being used will be described. FIG. 16 is a schematic view for explaining orientations of the power board 5 and control board 6 when the electric blower 200 is not being used. “When the electric blower 200 is not being used” refers to a state where the vacuum cleaner 300 including the electric blower 200 is held by the stand 310 in a standing position, as illustrated in FIG. 11. In FIG. 16, a direction of gravity is indicated by arrow G.

The suction direction A from the suction portion 304 to the dust collection container 302 of the vacuum cleaner 300 (or the longitudinal direction of the vacuum cleaner 300) is parallel to the direction of the axis C1 of the electric blower 200, as described above. Thus, in a state where the vacuum cleaner 300 is held by the stand 310 in a standing position, the axis C1 of the electric blower 200 is oriented in the vertical direction.

The normal directions of the surfaces 5A and 5B of the power board 5 and the normal directions of the surfaces 6A and 6B of the control board 6 are all parallel to the axis C1. Thus, in the state where the vacuum cleaner 300 is held by the stand 310 in a standing position, the surfaces 5A and 5B of the power board 5 and the surfaces 6A and 6B of the control board 6 are all horizontal. Also, since the power board 5 and control board 6 are located above the motor 100, the front surface 5A of the power board 5 and the front surface 6A of the control board 6 (which are both surfaces on the motor 100 side) are both lower surfaces.

Thus, dust adhering to the electronic parts (e.g., the switching elements 82a to 82d) disposed on the front surface 5A of the power board 5 and dust adhering to the electronic parts (e.g., the MOSFET 64) disposed on the front surface 6A of the control board 6 fall down by gravity.

Electronic parts, such as the MOSFET 64, disposed on the front surface 6A of the control board 6 have especially narrow wiring pitches. Thus, if dust sucked together with air through the suction portion 304 of the vacuum cleaner 300 passes through a filter of the dust collection container 302 and adheres to portions between wires of the electronic parts on the front surface 6A of the control board 6, this may cause a short circuit.

However, in the state where the vacuum cleaner 300 is held by the stand 310 in a standing position, since the front surface 6A of the control board 6 is a lower surface, dust adhering to the electronic parts on the front surface 6A of the control board 6 falls down by gravity. This can prevent a short circuit due to adhesion of dust to portions between wires of the electronic parts.

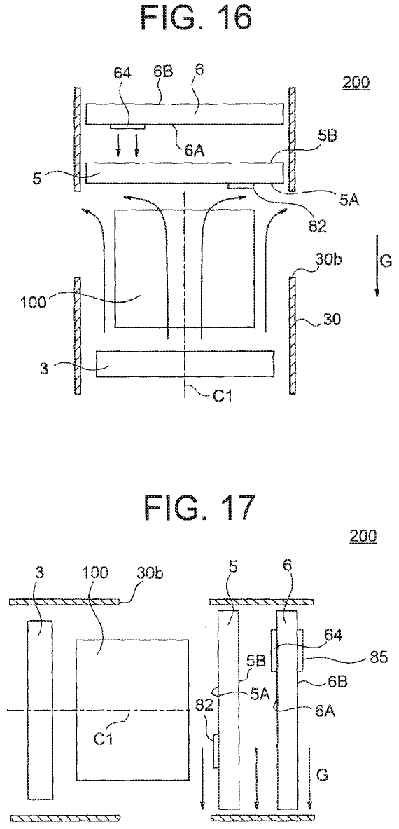

FIG. 17 is a schematic view for explaining orientations of the power board 5 and control board 6 when the electric blower 200 is being used. When the electric blower 200 is being used, i.e., when the vacuum cleaner 300 is being used, the grip 306 of the vacuum cleaner 300 is held by a user and the longitudinal direction of the vacuum cleaner 300 is slanted relative to the vertical direction, as illustrated in FIG. 10. Also, the width direction of the grip 306 (the direction indicated by arrow W in FIG. 10) is horizontal.

In this state, the suction direction A from the suction portion 304 to the dust collection container 302 of the vacuum cleaner 300, i.e., the direction of the axis C1 of the electric blower 200, is slanted relative to the vertical direction. In FIG. 17, for simplicity, the direction of the axis C1 of the electric blower 200 is horizontal (i.e., slanted by 90° relative to the vertical direction).

As described above, the normal directions of the surfaces 5A and 5B of the power board 5 and the normal directions of the surfaces 6A and 6B of the control board 6 are all parallel to the axis C1 (i.e., parallel to the suction direction A from the suction portion 304 to the dust collection container 302). Thus, when the vacuum cleaner 300 is being used as illustrated in FIG. 10, the surfaces 5A and 5B of the power board 5 and the surfaces 6A and 6B of the control board 6 are slanted relative to a horizontal plane (vertical in the example illustrated in FIG. 17).

Thus, dust adhering to the surfaces 5A and 5B of the power board 5 and dust adhering to the surfaces 6A and 6B of the control board 6 fall down by gravity. This can prevent a short circuit due to adhesion of dust to portions between wires of the electronic parts.

Although in FIG. 17 the normal directions of the surfaces 5A and 5B of the power board 5 and the surfaces 6A and 6B of the control board 6 are horizontal, it is possible to allow the dust to fall down when the normal directions are slanted relative to the vertical direction (i.e., when each surface is not horizontal).

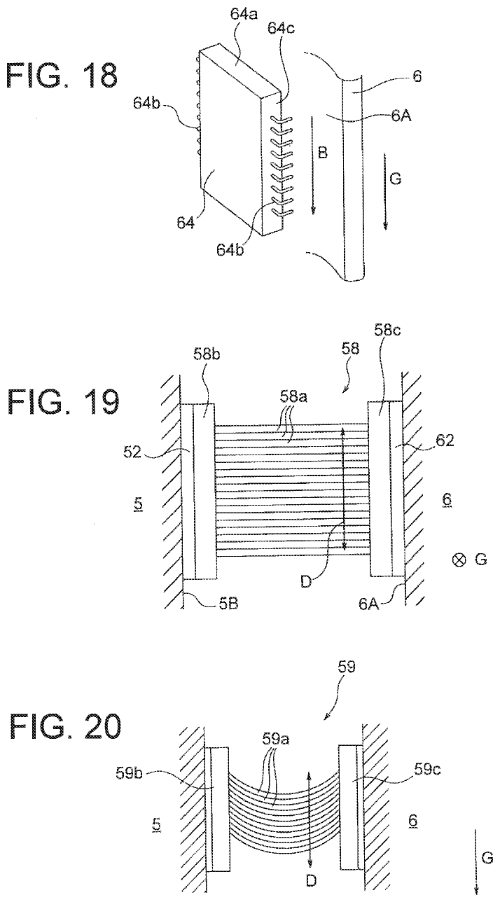

Next, a direction in which pins of an electronic part (here, the MOSFET 64) disposed in the control board 6 are arranged will be described. FIG. 18 is a perspective view illustrating the MOSFET 64 disposed in the control board 6. The MOSFET 64 includes a package 64a covering a device, and multiple pins 64b (lead terminals) projecting from the package 64a. Here, the multiple pins 64b are formed to be arranged in one direction along side surfaces 64c of the package 64a. Such an electronic part is referred to as a multipin part. It is sufficient that the number of the pins 64b be two or more.

The arrangement direction B of the pins 64b of the MOSFET 64 is slanted relative to a horizontal direction when the electric blower 200 is being used, i.e., when the vacuum cleaner 300 is being used.

More specifically, the arrangement direction B of the pins 64b of the MOSFET 64 is perpendicular to both the direction of the axis C1 illustrated in FIG. 17 (or the suction direction A from the suction portion 304 to the dust collection container 302 of the vacuum cleaner 300) and the width direction W of the grip 306 illustrated in FIG. 10.

Thus, when a user holds the grip 306 and maintains the vacuum cleaner 300 at the attitude in FIG. 10, the arrangement direction B of the pins 64b of the MOSFET 64 is slanted relative to a horizontal direction. Thereby, dust adhering to the front surface 6A of the control board 6 falls by gravity along the arrangement direction B of the pins 64b.

Thus, dust is prevented from accumulating between the side surfaces 64c of the MOSFET 64 and the front surface 6A of the control board 6, for example. Thus, it is possible to prevent a short circuit due to adhesion of dust to portions between the pins 64b.

Although in FIG. 17 the arrangement direction B of the pins 64b of the MOSFET 64 is in the vertical direction (the direction of gravity indicated by arrow G), it is possible to allow the dust to fall when the arrangement direction B of the pins 64b of the MOSFET 64 is slanted relative to a horizontal direction.

Next, the connector 58 connecting the power board 5 and the control board 6 will be described. FIG. 19 is a plan view illustrating the connector 58 of the first embodiment. The connector 58 includes a connecting portion 58b connected to the terminal portion 52 of the power board 5, a connecting portion 58c connected to the terminal portion 62 of the control board 6, and multiple wires 58a connecting the connecting portions 58b and 58c.

A direction D in which the wires 58a of the connector 58 are arranged is horizontal both when the electric blower 200 is being used and when the electric blower 200 is not being used (i.e., when the vacuum cleaner 300 is being used and when the vacuum cleaner 300 is not being used). More specifically, the arrangement direction D of the wires 58a of the connector 58 is parallel to the width direction W (FIG. 10) of the grip 306 of the vacuum cleaner 300.

Thus, when the wires 58a of the connector 58 sag by gravity, all the wires 58a sag in the direction of gravity indicated by arrow G in the same manner. Thus, concentration of load on one of the wires 58a does not occur.

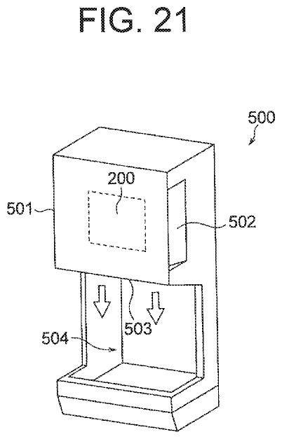

FIG. 20 is a plan view illustrating a connector 59 of a comparative example. The connector 59 of the comparative example includes connecting portions 59b and 59c, and multiple wires 59a arranged in a row, as with the connector 58 of the first embodiment.

However, in the connector 59 of the comparative example, a direction D in which the multiple wires 59a are arranged is vertical when the electric blower 200 is being used (i.e., when the vacuum cleaner 300 is being used). More specifically, the arrangement direction D of the wires 59a of the connector 59 is perpendicular to the width direction W (FIG. 10) of the grip 306.

Thus, when the wires 59a of the connector 59 of the comparative example sag by gravity, since upper wires 59a press lower wires 59a as illustrated in FIG. 20, lower wires 59a are subjected to greater loads.

On the other hand, in the connector 58 of the first embodiment, since the arrangement direction D of the wires 58a of the connector 58 is horizontal both when the electric blower 200 is being used and when the electric blower 200 is not being used, all the wires 58a sag in the same manner, and it is possible to prevent concentration of load. Thus, it is possible to prevent degradation of the wires 58a due to concentration of load.

### <Advantages of Embodiment>

As described above, in the electric blower 200 of the first embodiment, the power board 5 including the switching elements 82a to 82d is disposed in an airflow path (the first airflow path P1 and second airflow path P2) through which airflow by the rotor 31 (fan) flows, and the lead wire 51 of the power board 5 projects into the airflow. Thus, it is possible to dissipate heat of the lead wire 51 with the airflow and cool the power board 5.

Further, the lead wire 51 is litz wire. This can reduce skin effect when high-frequency current flows, and reduce temperature rise.

Further, the lead wire 51 is disposed on the surface of the power board 5 on the side opposite the rotor 31 (i.e., the back surface 5B). This can prevent the lead wire 51 from being exposed to an excessively strong airflow, thereby preventing the lead wire 51 from coming off.

Further, the coating 55 of moisture proof material is formed on the back surface 5B of the power board 5, and the lead wire 51 is disposed to be exposed from the coating 55. This can prevent dielectric breakdown or corrosion and wire breakage due to adhesion of liquid or the like to the back surface 5B of the power board 5.

Further, the electrolytic capacitors 81 are disposed on the side of the central portion 5C of the power board 5 opposite the battery 80. This can reduce the effect of heat from the battery 80 and prevent reduction in lifetime of the electrolytic capacitors 81.

Further, the motor 100 is disposed upstream of the power board 5 in a blowing direction of the rotor 31 (fan). Thus, it is possible to cause air to strike the power board 5 through the motor 100 and efficiently cool the motor 100 and power board 5.

Further, the power board 5 faces the first airflow path P1 outside the motor frame 4 and the second airflow path P2 inside the motor frame 4. Thus, it is possible to expose the power board 5 to a sufficient amount of airflow and effectively cool the switching elements 82a to 82d or the like.

Further, the control board 6 including electronic parts such as the microcomputer 85 is further provided in addition to the power board 5. Thus, compared to a case where the electric blower 200 is driven by a single board, it is possible to reduce respective outer diameters of the power board 5 and control board 6 and reduce a diameter of the electric blower 200.

Further, the vacuum cleaner 300 uses the electric blower 200. Thus, it is possible to obtain high operating efficiency by virtue of improvement in efficiency of cooling of the power board 5 and control board 6.

Further, when the vacuum cleaner 300 is not being used, it is held by the stand 310 (or a holder) in such a manner that the suction direction A from the suction portion 304 to the dust collection container 302 is oriented in the vertical direction. This allows the vacuum cleaner 300 to be placed in a small area.

Further, when the vacuum cleaner 300 is not being used, the front surface 6A of the control board 6 is a lower surface, which allows dust adhering to the front surface 6A of the control board 6 to fall down by gravity.

Further, the normal directions of the surfaces 5A and 5B of the power board 5 and the normal directions of the surfaces 6A and 6B of the control board 6 are slanted relative to the vertical direction when the vacuum cleaner 300 is being used. Thus, when the vacuum cleaner 300 is being used, the surfaces 5A and 5B of the power board 5 and the surfaces 6A and 6B of the control board 6 are slanted relative to the horizontal plane, which can allow dust adhering to these surfaces to fall by gravity.

Further, the arrangement direction B of the pins 64b of the electronic part (e.g., the MOSFET 64) is slanted relative to a horizontal direction when the vacuum cleaner 300 is being used. This can prevent foreign matter from accumulating between the side surfaces of the electronic part and the front surface 6A of the control board 6.

Further, the arrangement direction D of the wires 58a of the connector 58 connecting the power board 5 and the control board 6 is oriented in the horizontal direction both when the vacuum cleaner 300 is being used and when the vacuum cleaner 300 is not being used. This prevents concentration of load when the wires 58a sag under their own weight, and can prevent degradation of the wires 58a.

### <Hand Dryer>

A hand dryer using the electric blower 200 of the first embodiment will now be described. FIG. 21 is a schematic view illustrating a hand dryer 500 using the electric blower 200 of the first embodiment.

The hand dryer 500 includes a housing 501, and the electric blower 200, which is fixed in the housing 501. The electric blower 200 has, for example, the configuration illustrated in FIG. 1A. The housing 501 has an air inlet 502 and an air outlet 503, and has, under the air outlet 503, a hand insertion portion 504 into which a hand is inserted by a user. The electric blower 200 generates airflow, thereby sucking air outside the housing 501 through the air inlet 502 and blowing air to the hand insertion portion 504 through the air outlet 503. The direction of the axis C1 (FIG. 1A) of the electric blower 200 may be horizontal or vertical.

When the hand dryer 500 is turned on, electric power is supplied to the electric blower 200, and the electric blower 200 operates. When the electric blower 200 operates, the rotor 31 (FIG. 1A) is rotated by the motor 100 (FIG. 1A). Thereby, air outside the housing 501 is sucked through the air inlet 502 and blown through the air outlet 503. When a user inserts a hand into the hand insertion portion 504, the air blown through the air outlet 503 can blow off or evaporate water droplets on the hand.

In the hand dryer 500, unlike the vacuum cleaner 300 (FIGS. 10 and 11), foreign matter (dust) is less likely to be sucked together with air. Thus, the configurations for allowing foreign matter to fall described with reference to FIGS. 16 to 18 may be omitted.

Since the hand dryer 500 uses the electric blower 200, it can obtain high operating efficiency by virtue of improvement in efficiency of cooling of the power board 5 and control board 6.

While the preferred embodiment of the present invention has been specifically described above, the present invention is not limited to the above-described embodiment, and various modifications or changes can be made without departing from the gist of the present invention.

1. An electric blower comprising:
a fan;
a motor to drive the fan, the motor being disposed in an airflow path of the fan; and
a board disposed in the airflow path of the fan and including a switching element, the board being disposed downstream of the motor in a blowing direction of the fan;
wherein the board is disposed to face the motor, and
wherein the board includes a lead wire projecting into the airflow path, the lead wire being disposed on a surface of the board on a side opposite a surface of the board facing the fan.

2. The electric blower of claim 1, wherein the lead wire is litz wire.

3. (canceled)

4. The electric blower of claim 1, wherein
a coating of moisture proof material is formed on the surface of the board on which the lead wire is disposed, and
the lead wire is disposed to be exposed from the coating.

5. The electric blower of claim 1, comprising a battery that is a power source for the fan,
wherein the board includes an electrolytic capacitor on a side of a central portion of the board opposite the battery.

6. (canceled)

7. The electric blower of claim 1, wherein
the motor includes a frame,
the airflow path includes a first airflow path outside the frame and a second airflow path inside the frame, and
the board faces the first airflow path and the second airflow path.

8. The electric blower of claim 1, wherein
the board is a first board, and
the electric blower further comprises, downstream of the first board in-a the blowing direction of the fan, a second board including an electronic part.

9. A vacuum cleaner comprising:
a suction portion including a suction port;
a dust collection container to store dust;
the electric blower of claim 1, the electric blower sucking air containing dust through the suction portion into the dust collection container; and
a grip to be held by a user.

10. The vacuum cleaner of claim 9, wherein when the vacuum cleaner is not being used, the vacuum cleaner is held by a holder so that a direction in which the air is sucked from the suction portion to the dust collection container is oriented in a vertical direction.

11. The vacuum cleaner of claim 9, wherein
the board of the electric blower is a first board, and
the vacuum cleaner further comprises, in the airflow path of the electric blower, a second board including an electronic part.

12. The vacuum cleaner of claim 11, wherein the electronic part is located on a lower surface of the second board when the vacuum cleaner is not being used.

13. The vacuum cleaner of claim 11, wherein the electronic part is disposed on a surface of the second board on the fan side.

14. The vacuum cleaner of claim 11, wherein a normal direction of a surface of the first board and a normal direction of a surface of the second board are slanted relative to a vertical direction when the vacuum cleaner is being used.

15. The vacuum cleaner of claim 11, wherein a normal direction of a surface of the first board and a normal direction of a surface of the second board are parallel to a direction in which the air is sucked from the suction portion to the dust collection container.

16. The vacuum cleaner of claim 11, wherein
the electronic part includes a plurality of pins arranged in one direction, and
the direction in which the plurality of pins are arranged is slanted relative to a horizontal direction when the vacuum cleaner is being used.

17. The vacuum cleaner of claim 11, wherein
the electronic part includes a plurality of pins arranged in one direction, and
the direction in which the plurality of pins are arranged is perpendicular to both a direction in which the air is sucked from the suction portion to the dust collection container and a width direction of the grip.

18. The vacuum cleaner of claim 11, further comprising a connector that electrically connects the first board and the second board, wherein
the connector includes a plurality of wires arranged in one direction, and
the direction in which the plurality of wires are arranged is oriented in a horizontal direction both when the vacuum cleaner is being used and when the vacuum cleaner is not being used.

19. The vacuum cleaner of claim 11, further comprising a connector that electrically connects the first board and the second board, wherein
the connector includes a plurality of wires arranged in one direction, and
the direction in which the plurality of wires are arranged is parallel to a width direction of the grip.

20. A hand dryer comprising:
a housing including an air inlet and an air outlet; and
the electric blower of claim 1, the electric blower being disposed in the housing, and sucking air through the air inlet and blowing air through the air outlet.
